(19) United States
(12) Patent Application Publication
(10) Pub. No.: US 2021/0294284 A1
(43) Pub. Date: Sep. 23, 2021

(54) EQUIPMENT MONITORING SYSTEM

(71) Applicant: Matthew R. Hugg, Pella, IA (US)

(72) Inventor: Matthew R. Hugg, Pella, IA (US)

(21) Appl. No.: 17/205,147

(22) Filed: Mar. 18, 2021

Related U.S. Application Data
(60) Provisional application No. 62/991,144, filed on Mar. 18, 2020.

(51) Int. Cl. G05B 15/02; G05B 23/02

(52) U.S. Cl. CPC G05B 15/02; G05B 23/027; G05B 2223/06; G05B 23/0272

(57) ABSTRACT

An equipment monitoring system including a plurality of sensors attached to components of an insulation blowing machine. The components of the insulation blowing machine include a blower, a hose, a blower hopper and a material staging area. The sensors transmit information to a central computer which detects the operations parameters of the blowing machine components and displays them in real time, as well as sends alerts if operating outside of preset perimeters.

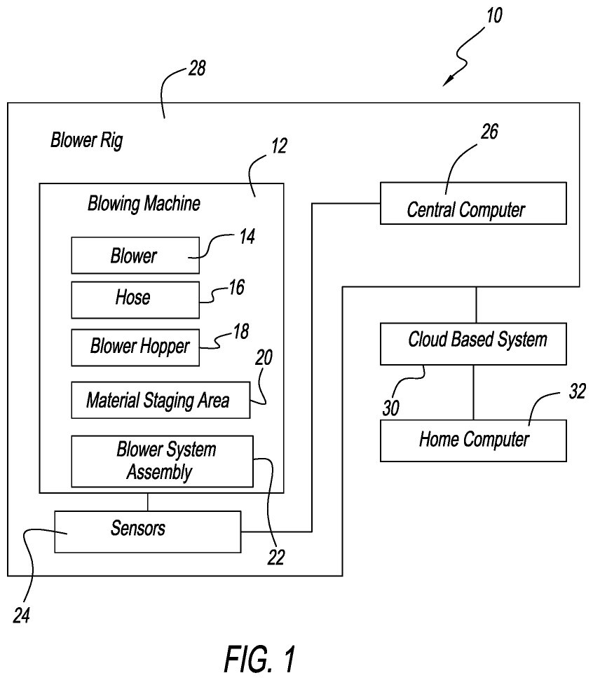

### CROSS REFERENCE TO RELATED APPLICATION

This application claims the benefit of U.S. Provisional Application No. 62/991,144, filed Mar. 18, 2020, the contents of this application is hereby incorporated by reference in its entirety.

### BACKGROUND OF THE INVENTION

The present invention is directed to an equipment monitoring system and more particularly to an equipment monitoring system for use with a blowing machine.

### SUMMARY OF THE INVENTION

An equipment monitoring system includes a plurality of sensors that are attached to components of an insulation blowing machine. The components of the blowing machine include, but are not limited to, a blower, a hose, a blower hopper, and a materials staging area. Also connected to the plurality of sensors is a central computer that receives information from the sensors concerning operating parameters of the blowing machine components that are critical to the proper functions and operation for the blowing machine and the proper installation of the finished product.

The central computer, which is disposed within a blowing rig assembly or the like is connected to a cloud based system and the cloud based system is connected to a website and a home computer. The central computer compares the detected information with pre-determined parameters and if operating outside of predetermined parameters sends out alerts. The central computer also displays the detected parameters in real time.

### BRIEF DESCRIPTION OF THE DRAWINGS

The Figure is a schematic view of the environment of an equipment monitoring system.

### DETAILED DESCRIPTION OF THE PREFERRED EMBODIMENTS

Referring to the figure, an equipment monitoring system 10 is retrofitted and/or attached to an existing fiberglass and/or cellulose insulation blowing machine 12. The blowing machine 12 includes a blower 14, a hose 16, a blower hopper 18, a material staging area 20 and other locations associated with a blower system assembly 22. A plurality of sensors 24 are attached to the components of the blowing machine 12 and monitor various functions and operating parameters of the blowing machine, including but not limited to, flow, speed, pressure and other elements critical to the proper function/operation of the blowing machine 12 as well as the proper installation of the finished product.

The sensors 24 are connected to a central computer 26 that operates inside the blower truck, trailer, or rig 28 and collects and logs information detected and transmitted by the sensors 24. A cloud based system 30 is connected to the central computer 26. A home computer 32, also connected to the cloud based system 30 is connected to a website that displays real time operational parameters of the blower and truck, trailer, rig assembly 28 detected by the plurality of sensors 24.

The detected parameters are displayed using real time graphing. Also, yields, product quality, crew performance, and other metrics can be measured and alerts may be sent via push notification, text, e-mail, and the like to any relevant parties including, but not limited to, the applicator, managers, and others, in the event that any detected parameters exceed acceptable predetermined thresholds.

From the above discussion and accompanying figures and claims it will be appreciated that the equipment monitoring system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. An equipment monitoring system, comprising:
a plurality of sensors connected to a blower, hose, blower hopper, and material staging area of a blowing machine;
a central computer connected to the plurality of sensors; and
wherein the central computer provides alerts based upon detected parameters of the blowing machine.

2. The system of claim 1 wherein the detected parameters are displayed using real time graphing.

3. The system of claim 1 wherein the central computer is connected to a cloud based system.

4. The system of claim 3 wherein a website is connected to the cloud based system and displays real time parameters of the blower machine and a blower rig assembly.
